(19) United States
(12) Patent Application Publication
(10) Pub. No.: US 2026/0341984 A1
(43) Pub. Date: Oct. 29, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Tetsuya MIYAMURA, Mie (JP); Akiko SUZUKI, Mie (JP)

(21) Appl. No.: 19/110,809

(22) PCT Filed: Aug. 31, 2023
(86) PCT No.: PCT/JP2023/031703

§ 371 Date: Mar. 12, 2025

(30) Foreign Application Priority Data
Sep. 21, 2022 (JP) 2022-149879

(51) Int. Cl. H01R 9/22; H01R 9/24

(52) U.S. Cl. CPC H01R 9/223; H01R 9/24

(57) ABSTRACT

The purpose of the present invention is to simplify the shape of a housing and achieve further reduction in the size of a connector. This connector holds a terminal, the connector comprising: a housing in which a cavity that can house the terminal is formed; and a retainer that can be mounted on the housing in a provisional mounting position and a main mounting position, the retainer including a lance that can be provisionally locked to the terminal in the cavity at the provisional mounting position, and a locking projection that can be locked to the terminal in the cavity at the actual mounting position.

### TECHNICAL FIELD

The present disclosure relates to a connector.

### BACKGROUND

Patent Document 1 discloses a connector provided with a housing body portion formed with a cavity, into and from which a terminal fitting is insertable and withdrawal, and a retainer. The housing body portion is formed with a locking lance to be primarily locked to the terminal fitting. The retainer is formed with a locking protrusion to be secondarily locked to the terminal fitting.

### PRIOR ART DOCUMENT

### Patent Document

Patent Document 1: JP 2007-305473 A

### SUMMARY OF THE INVENTION

### Problems to be Solved

Here, it is required to simplify the shape of a housing and further reduce the size of the connector.

Accordingly, the present disclosure aims to simplify the shape of a housing and further reduce the size of a connector.

### Means to Solve the Problem

The present disclosure is directed to a connector for holding a terminal, the connector being provided with a housing formed with a cavity capable of accommodating the terminal and a retainer attachable to the housing at a temporarily attached position and a completely attached position, the retainer including a locking lance temporarily lockable to the terminal in the cavity at the temporarily attached position and a locking protrusion lockable to the terminal in the cavity at the completely attached position.

### EFFECT OF THE INVENTION

According to the present disclosure, it is possible to simplify the shape of a housing and further reduce the size of a connector.

### BRIEF DESCRIPTION OF THE DRAWINGS

FIG. 1 is a perspective view showing a connector according to an embodiment.

FIG. 2 is an exploded perspective view showing the connector.

FIG. 3 is an exploded perspective view showing the connector.

FIG. 4 is a partial section along IV-IV of FIG. 1.

FIG. 5 is a partial section along V-V of FIG. 1.

FIG. 6 is a section showing a temporarily attached state of a retainer in a cross-section along IV-IV of FIG. 1.

FIG. 7 is a section showing the temporarily attached state of the retainer in a cross-section along V-V of FIG. 1.

### DETAILED DESCRIPTION TO EXECUTE THE INVENTION

### Description of Embodiments of Present Disclosure

First, embodiments of the present disclosure are listed and described.

The connector of the present disclosure is as follows.

(1) The connector of the present disclosure is for holding a terminal and provided with a housing formed with a cavity capable of accommodating the terminal and a retainer attachable to the housing at a temporarily attached position and a completely attached position, the retainer including a locking lance temporarily lockable to the terminal in the cavity at the temporarily attached position and a locking protrusion lockable to the terminal in the cavity at the completely attached position.

According to the present disclosure, the locking lance to be temporarily locked to the terminal is provided in the retainer. Thus, the shape of the housing can be simplified and the connector can be reduced in size.

(2) In the connector of (1), the terminal may include a recess recessed in a part in an extension direction thereof, and the locking lance may be temporarily lockable to the recess and the locking protrusion may be lockable to the recess.

In this case, the locking lance can be temporarily locked to the recess, to which the locking protrusion is locked. Thus, the terminal may not be separately formed with a part to be temporarily locked by the locking lance. In this way, the terminal can be simplified and reduced in size, which also contributes to the size reduction of the connector.

(3) In the connector of (1) or (2), the housing may include a complete attachment opening and a temporary attachment opening, the retainer may include a retainer body to be attached to the complete attachment opening and a pair of locking wall portions extending from both sides of the retainer body along both sides of the housing, the locking protrusion may be formed to project into the cavity from the retainer body, and the locking lance may be formed to project in the same direction as the locking wall portions at an intermediate position in an extension direction of the retainer body as to be arrangeable in the temporary attachment opening, and resiliently deformable along a direction intersecting an extension direction of the cavity.

In this case, the locking lance is formed to project in the same direction as the locking wall portions at the intermediate position in the extension direction of the retainer body so as to be arrangeable in the temporary attachment opening, and resiliently deformed along the direction intersecting the extension direction of the cavity. Thus, a configuration for forming the locking lance can be made smaller as compared to the case where the locking lance is postured to extend along the extension direction of the cavity. In this way, the size in the front-rear direction of the connector can be reduced.

(4) In the connector of (3), a base end of the locking lance may be integrally connected to the locking protrusion. In this way, the locking lance is easily reinforced even if a projecting length of the locking lance is increased.

(5) In the connector of (3) or (4), the locking lance may include a resilient piece and a temporary locking protrusion projecting toward the cavity at a position separated from a base end of the resilient piece, the locking lance may be arranged in the temporary attachment opening and the temporary locking protrusion may project into the cavity and be temporarily lockable to the terminal in the cavity with the retainer located at the temporarily attached position, and the temporary locking protrusion may move beyond the terminal to release temporary locking for the terminal and the locking protrusion may project into the cavity to be lockable to the terminal in the cavity with the retainer located at the completely attached position.

In this way, the locking lance can be temporarily locked to the terminal with the retainer located at the temporarily attached position. If the retainer is pushed and moved to the completely attached position, the temporary locking of the locking lance and the terminal is released and the locking protrusion can be locked to the terminal without being obstructed by the locking lance.

(6) In the connector of (5), the temporary locking protrusion may have a first guide surface for gradually reducing a projecting dimension of the temporary locking protrusion toward a side where the terminal is inserted in an extension direction of the cavity and a second guide surface for gradually reducing a projecting dimension of the temporary locking protrusion toward a tip side of the locking lance.

In this case, the temporary locking protrusion projects into the cavity with the retainer located at the temporarily attached position. If the terminal is inserted into the cavity, the terminal contacts the first guide surface and resiliently deforms the locking lance in a direction retracting from the cavity. If the terminal is further pushed in, the locking lance resiliently returns to an original shape and the temporary locking protrusion can be temporarily locked to the terminal. If the retainer is pushed from the temporarily attached position toward the completely attached position, the second guide surface contacts the terminal and the locking lance is resiliently deformed in the direction retracting from the cavity. Thus, the temporary locking protrusion rides over the terminal and the temporary locking of the locking lance and the terminal is released.

(7) In the connector of any one of (3) to (6), the housing may include a vertical wall along the extension direction of the cavity and a projecting direction of the locking wall portions, and the temporary attachment opening may be a slit formed in the vertical wall and along the projecting direction of the locking wall portions.

In this case, the retainer is guided by a configuration in which the locking lance is arranged in the slit-like temporary attachment opening. Further, the locking lance can be resiliently deformed, utilizing a space in the slit.

(8) In the connector of (7), the vertical wall may include an outer wall exposed on any one of side surfaces of the housing, and the temporary attachment opening may be a slit formed in the outer wall.

As just described, if the temporary attachment opening is the slit formed in the outer wall, a space for resiliently deforming the locking lance outward is easily ensured.

(9) In the connector of (7) or (8), the housing may include a pair of temporary attachment locking portions to be temporarily locked to the pair of locking wall portions with the retainer located at the temporarily attached position and a pair of complete attachment locking portions to be locked to the pair of locking wall portions with the retainer located at the completely attached position, the pair of temporary attachment locking portions and the pair of complete attachment locking portions may be formed into a protrusion shape elongated in the extension direction of the cavity, and the temporary attachment opening may be a slit formed to cross at least one of the pair of temporary attachment locking portions and at least one of the pair of complete attachment locking portions.

In this case, the locking wall portions are locked to the temporary attachment locking portions or the complete attachment locking portions near a position where the locking lance is guided by the slit-like temporary attachment opening. Thus, the locking wall portions are smoothly locked to the temporary attachment locking portions or the complete attachment locking portions.

### Details of Embodiment of Present Disclosure

A specific example of a connector of the present disclosure is described below with reference to the drawings. Note that the present disclosure is not limited to these illustrations, but is represented by claims and intended to include all changes in the scope of claims and in the meaning and scope of equivalents.

### Embodiment

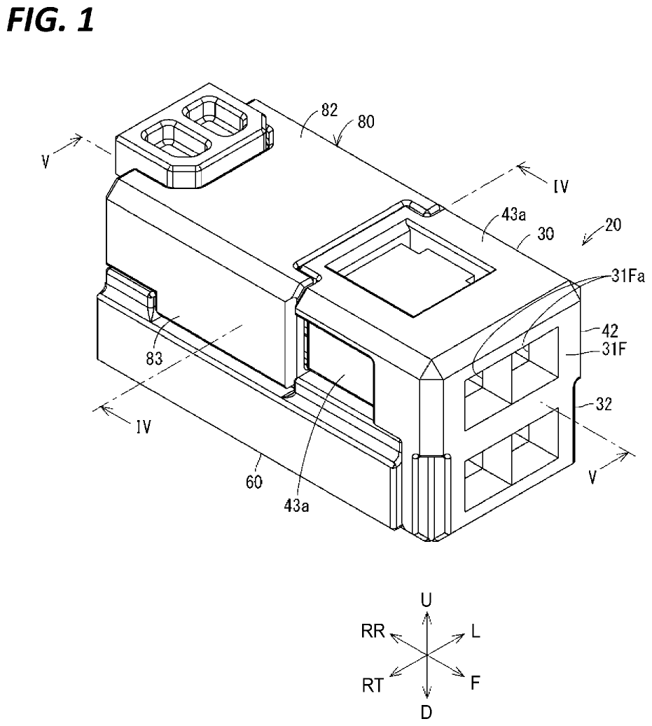

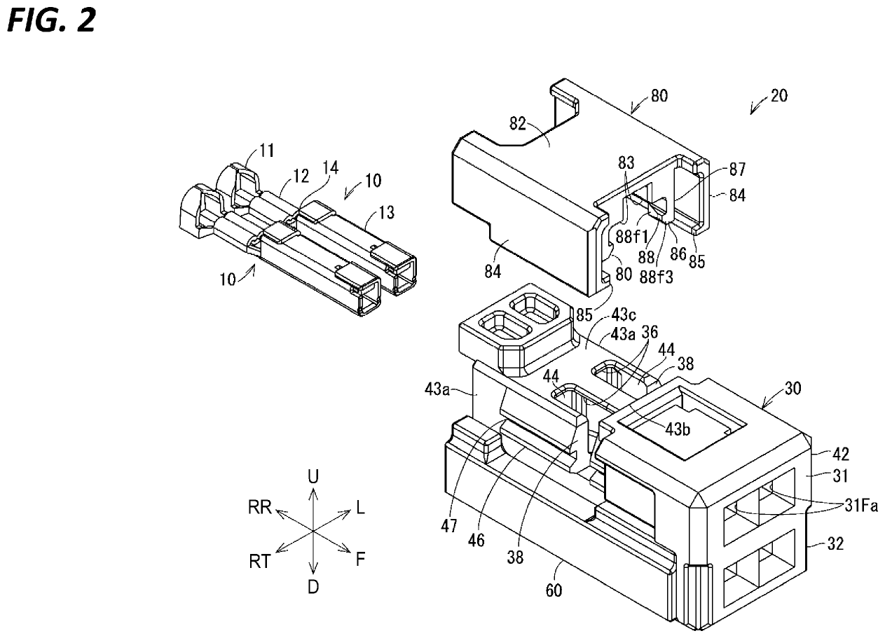

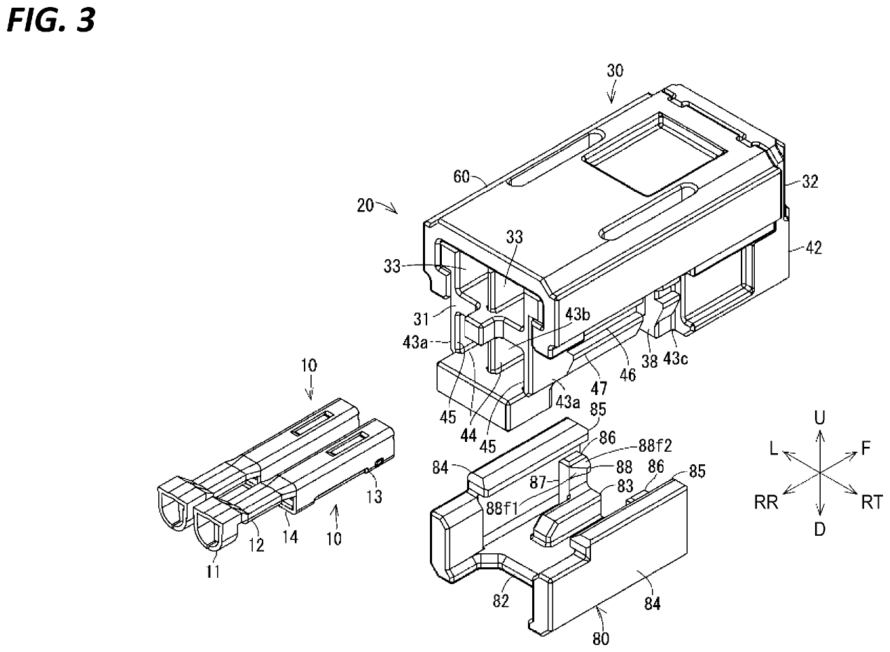

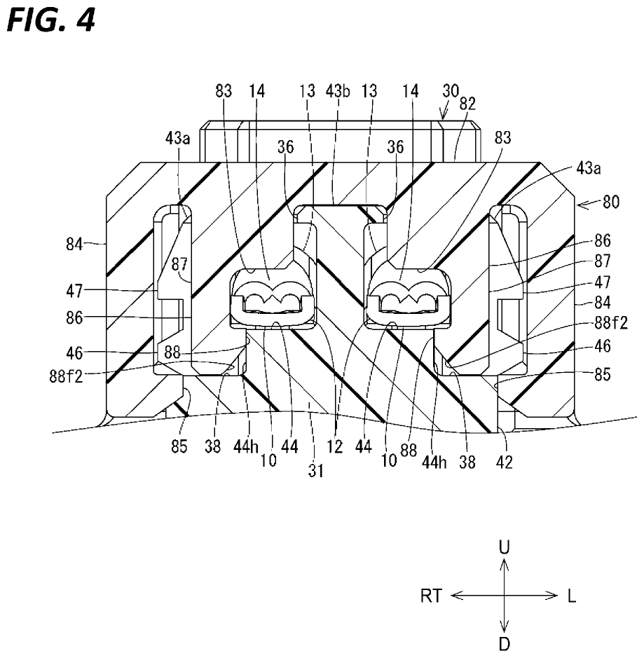

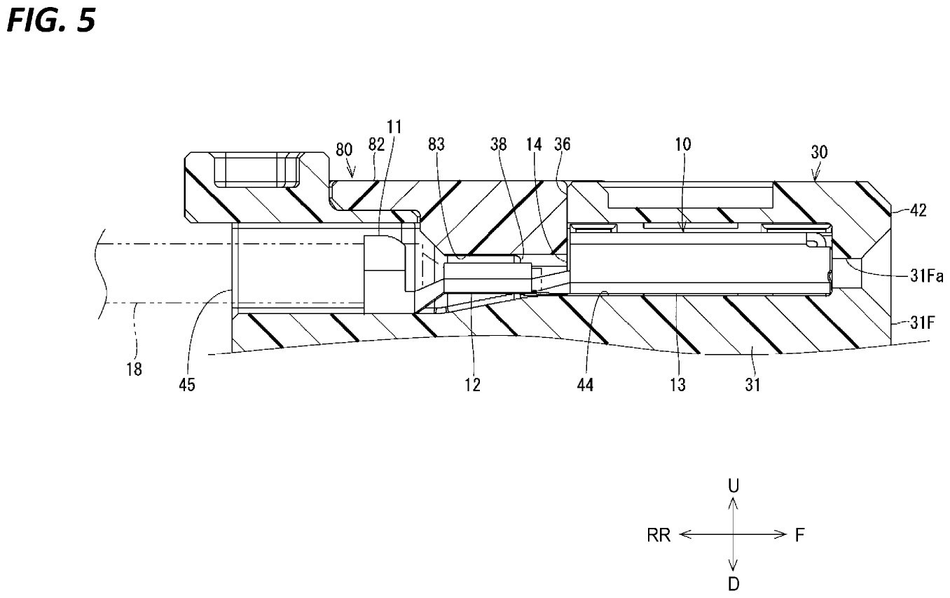

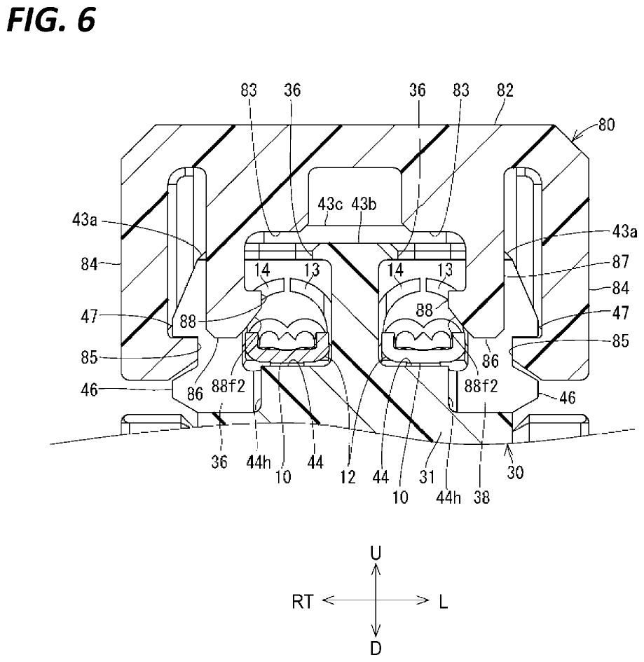

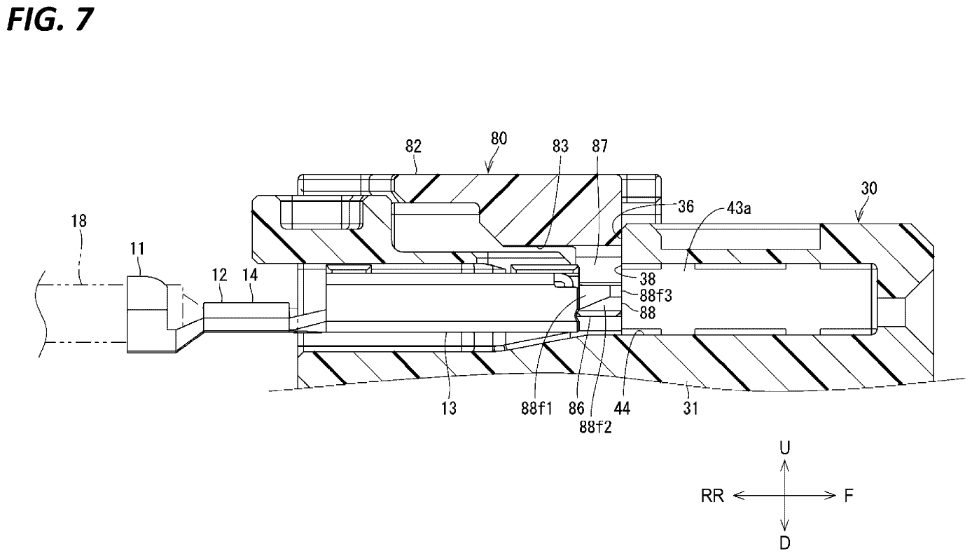

Hereinafter, a connector according to an embodiment is described. FIG. 1 is a perspective view showing a connector 20. FIGS. 2 and 3 are exploded perspective views showing the connector 20. FIG. 4 is a partial section along IV-IV of FIG. 1. FIG. 5 is a partial section along V-V of FIG. 1. A wire 18 is shown by a two-dot chain line in FIG. 5. FIG. 6 is a section showing a temporarily attached state of a retainer in a cross-section along IV-IV of FIG. 1 and FIG. 7 is a section showing the temporarily attached state of the retainer in a cross-section along V-V of FIG. 1.

<overall Structure of Connector>

The overall structure of the connector 20 is described. The connector 20 holds terminals 10.

The terminal 10 is formed, such as by press-working a metal plate. The terminal 10 is provided with a coating crimping portion 11, a core wire crimping portion 12 and a terminal connecting portion 13. The coating crimping portion 11 is a part to be crimped to a coating in an end part of the wire 18. The core wire crimping portion 12 is a part to be crimped to a core wire exposed in the end part of the wire 18. The terminal connecting portion 13 is a part to be connected to a mating terminal and, for example, formed into a tubular shape. The coating crimping portion 11, the core wire crimping portion 12 and the terminal connecting portion 13 are linearly arranged in this order. The coating crimping portion 11 and the terminal connecting portion 13 are thicker than the core wire crimping portion 12. Thus, when the terminal 10 is observed from a lateral side, a recess 14 recessed in a part in an extension direction of the terminal 10 is formed between the coating crimping portion 11 and the terminal connecting portion 13 above the core wire crimping portion 12.

In this embodiment, the connector 20 holds a plurality of the terminals 10. More specifically, a plurality of (e.g. two) terminals 10 are held separately in each of a plurality of stages (e.g. two stages). In each stage, the plurality of terminals 10 are arranged in parallel in a row. Note that the plurality of terminals 10 may be terminals of the same size and same material or may be terminals of different sizes and different materials. Note that the number of the terminals 10 to be held by the connector 20 is arbitrary.

The connector 20 is provided with a housing 30 and a retainer 80. The plurality of terminals 10 at least in one stage are held not to come out from the housing 30 by the retainer 80. In this embodiment, the connector 20 is further provided with a cover 60. The cover 60 is attached to the housing 30 on a side opposite to the retainer 80. The plurality of terminals 10 in the other stage are held not to come out from the housing 30 by the cover 60.

In the following description, the side of the terminal connecting portion 13 and the side of the coating crimping portion 11 in the extension direction of the terminal 10 may be referred to as a front side and a rear side. Further, the side of the cover 60 and the side of the retainer 80 may be referred to as a lower side and an upper side. Further, a lateral direction may be referred to, assuming a state standing on the cover 60 and facing forward.

The housing 30 is made of resin or the like and provided with terminal accommodating portions 32, 42. In this embodiment, the housing 30 is provided with the terminal accommodating portion 32 on a lower side and the terminal accommodating portion 42 on an upper side. The lower terminal accommodating portion 32 includes cavities 34 for accommodating the terminals 10. In this embodiment, the lower terminal accommodating portion 32 includes a plurality of (here, two) cavities 34 arranged in parallel. The upper terminal accommodating portion 42 includes cavities 44 for accommodating the terminals 10. In this embodiment, the upper terminal accommodating portion 42 includes a plurality of (here, two) cavities 44 arranged in parallel.

The retainer 80 is united with the upper terminal accommodating portion 42 and holds the terminals 10 in the upper cavities 44. That is, the terminals 10 are inserted into the cavities 44 in a state before the retainer 80 is completely attached. With the terminals 10 inserted in the cavities 44, the retainer 80 is completely attached to the upper terminal accommodating portion 42. Then, the terminals 10 are prevented from coming out from the upper cavities 44.

The cover 60 is united with the lower terminal accommodating portion 32 and holds the terminals in the lower cavities 34. That is, the terminals 10 are set in the lower cavities 34 in a state before the cover 60 is attached to the lower terminal accommodating portion 32. In this state, the cover 60 is attached to the lower terminal accommodating portion 32. Then, the terminals 10 are prevented from coming out from the lower cavities 34.

It is not essential that this connector is provided with the cover 60 and the terminals 10 to be held by the cover 60.

A configuration for holding the terminal 10 by the retainer 80 is more specifically described.

### <Concerning Holding Structure by Retainer>

The retainer 80 is configured to be attachable to the housing 30 at a temporarily attached position and a completely attached position. Complete attachment is a state where the retainer 80 locks the terminals 10 to prevent the terminals 10 from coming out in a used state of the connector 20. With the retainer 80 attached to the housing 30 at the completely attached position, the terminals 10 are held in the cavities 44 without coming out from the housing 30 even if the connector 20 is carried or inserted into or withdrawn from a mating connector. Temporary attachment is a state where the terminals 10 are temporarily lockable in a state before the completely attached state is reached. A holding force for the terminals 10 by the retainer 80 in the temporarily attached state is assumed to be smaller than a holding force for the terminals 10 by the retainer 80 in the completely attached state. For example, the holding force for the terminals 10 by the retainer 80 in the temporarily attached state may be of such a magnitude as to be able to hold the terminals 10 during an operation of moving the retainer 80 from the temporarily attached position to the completely attached position.

More specifically, the housing 30 includes a partitioning plate portion 31 for partitioning the cavities 44 in the upper stage from below. In this embodiment, the partitioning plate portion 31 is located between the lower terminal accommodating portion and the lower terminal accommodating portion and partitions between the lower cavities 34 and the upper cavities 44. The partitioning plate portion 31 can be grasped as a bottom plate located on the bottoms of the cavities 44 in the upper stage. The housing 30 includes vertical walls 43a, 43b extending upward from the partitioning plate portion 31. The vertical walls 43a, 43b are plate-like parts orthogonal to the partitioning plate portion 31 and extending along an extension direction of the cavities 44. The vertical walls 43a, 43b also extend along a projecting direction of locking wall portions 84 to be described later. The vertical walls 43a, 43b include a pair of outer walls 43a located on both sides of the housing 30. The pair of outer walls 43a are exposed on a left or right outer side of the housing 30. Further, the vertical walls 43a, 43b include an intermediate wall 43b partitioning between the plurality of cavities 44. The intermediate wall 43b is located between the pair of outer walls 43a, and the pair of outer wall 43a and the intermediate wall 43b are arranged in parallel at intervals in a width direction of the housing 30.

A front plate portion 31F extending in a direction orthogonal to a front-rear direction is provided on the front edge of the housing 30. The front plate portion 31F is located on the front ends of the cavities 44. The terminals 10 arranged in the cavities 44 are restricted from moving forward by contacting the front plate portion 31F. The front plate portion 31F is formed with connection holes 31Fa, through which mating terminals (e.g. male terminals including elongated plate portions or pin-shaped parts) are insertable. The mating terminal can be connected to the terminal 10 in the cavity 44 through this connection hole 31Fa.

Openings defined by the pair of outer walls 43a and the intermediate wall 43b on a side opposite to the partitioning plate portion 31 are at least partially closed by a ceiling plate portion 43c. The upper terminal accommodating portion 42 is configured to include an upper part of the partitioning plate portion 31, the pair of outer walls 43a, the intermediate wall 43b, the ceiling plate portion 43c and the front plate portion 31F, and the plurality of cavities 44 are formed in gaps between the pair of outer walls 43a and the intermediate wall 43b. The cavities 44 include rear openings, and the terminals 10 are inserted into the cavities through the rear openings.

The housing 30 includes complete attachment openings 36 and temporary attachment openings 38.

In this embodiment, out of the ceiling plate portion 43c of the housing 30, an intermediate part in the extension direction of the cavities 44 is partially recessed, and the temporary attachment openings 36 are formed in parts of the recessed parts. With the front end of the terminal 10 arranged in the cavity 44 held in contact with the front plate portion 31F, at least a part of the recess 14 of the terminal 10 can be exposed to the outside of the housing 30 through the complete attachment opening 36.

Further, rear parts of the pair of outer walls 43a of the housing 30 are partially recessed, and the temporary attachment openings 38 are formed in parts of the recessed parts. The temporary attachment opening 38 is in the form of a slit extending in a direction orthogonal to the extension direction of the cavity 44. The temporary attachment opening 38 is also a slit along the projecting direction of the locking wall portion 84 to be described later. In the extension direction of the cavity 44, at least a part of the formation position of the temporary attachment opening 38 overlaps at least a part of the complete attachment opening 36. In this embodiment, the temporary attachment opening 38 is located at a position in front of the complete attachment opening 36 in the extension direction of the cavity 44. With the front end of the terminal 10 arranged in the cavity 44 held in contact with the front plate portion 31F, at least a part of the recess 14 of the terminal 10 can be exposed to the outside of the housing 30 through both the complete attachment opening 36 and the temporary attachment opening 38 (see FIG. 6).

Note that the temporary attachment opening 38 extends downward beyond the bottom surface on a side opposite to the complete attachment opening 36 in the cavity 44. A recess 44h is partially formed in a bottom surface part of the cavity 44 at a position corresponding to the tip of the temporary attachment opening 38. This recess is continuous with the temporary attachment opening 38 and a temporary locking protrusion 88 of a locking lance 86 is arranged in this recess 44h in the completely attached state (see FIGS. 4 and 6).

The retainer 80 is attachable to the housing 30 at the temporarily attached position and the completely attached position. The retainer 80 includes the locking lances 86 and locking protrusions 83. With the retainer 80 attached at the temporarily attached position, the locking lances 86 can be temporarily locked to the terminals 10 in the cavities 44 and set in the temporarily attached state. Here, the locking lance 86 is temporarily locked to the terminal 10 by projecting into the cavity 44 from the temporary attachment opening 38. With the retainer 80 attached at the completely attached position, the locking protrusions 83 can be locked to the terminals 10 in the cavities 44 and set in the completely attached state. Here, the locking protrusion 83 can be locked to the terminal 10 by projecting into the cavity 44 from the complete attachment opening 36.

Specifically, the housing 30 includes a pair of temporary attachment locking portions 47 and a pair of complete attachment locking portions 46.

The pair of temporary attachment locking portions 47 are parts to be locked to a pair of the locking wall portions 84 of the retainer 80 with the retainer 80 located at the temporarily attached position.

The pair of complete attachment locking portions 46 are parts to be locked to the pair of locking wall portions 84 of the retainer 80 with the retainer 80 located at the completely attached position.

The pair of temporary attachment locking portions 47 project outward from the bottom surfaces of the recessed parts in the outer surfaces of the pair of outer walls 43a. The pair of temporary attachment locking portions 47 are formed into a shape including a part having a projecting dimension gradually reduced toward the tip of the outer wall 43a, i.e. an upper side.

The pair of complete attachment locking portions 46 project outward from the bottom surfaces of the recessed parts in the outer surfaces of the pair of outer walls 43a. The pair of complete attachment locking portions 46 are formed into a shape including a part having a projecting dimension gradually reduced toward the tip of the outer wall 43a, i.e. the upper side.

The pair of temporary attachment locking portions 47 are located on a side closer to the complete attachment openings 36, i.e. upper sides, than the pair of complete attachment locking portions 46. Thus, the retainer 80 can be locked by the pair of complete attachment locking portions 46 and set in the completely attached state by being pressed after being temporarily locked by the pair of temporary attachment locking portions 47 and set in the temporarily attached state.

The pair of complete attachment locking portions 46 and the pair of temporary attachment locking portions 47 are formed into a protrusion shape elongated along the extension direction of the cavities 44. The front ends of the pair of complete attachment locking portions 46 and the pair of temporary attachment locking portions 47 are located forward of the complete attachment openings 36 and, and the rear ends of the pair of complete attachment locking portions 46 and the pair of temporary attachment locking portions 47 are located rearward of the complete attachment openings 36.

The temporary attachment opening 38 extends to cross the complete attachment locking portion 46 and the temporary attachment locking portion 47 in each of the pair of outer walls 43a. Thus, if the housing 30 is observed from a lateral side, the slit-like temporary attachment opening 38 intersects intermediate parts in the extension direction of the complete attachment locking portion 46 and the temporary attachment locking portion 47. The temporary attachment opening 38 may cross the complete attachment locking portion 46 or the temporary attachment locking portion 47. The temporary attachment opening 38 may not cross the complete attachment locking portion 46 and the temporary attachment locking portion 47.

The retainer 80 includes a retainer body 82 and the pair of locking wall portions 84.

The retainer body 82 is a part to be attached to the complete attachment openings 36. Here, the retainer body 82 is in the form of a plate spreading to be able to collectively close the complete attachment openings 36 corresponding to the plurality of cavities 44. In this embodiment, an intermediate part in the front-rear direction of the ceiling plate portion 43c is partially recessed, and the retainer body 82 is in the form of a plate arrangeable in the recessed part of the ceiling plate portion 43c. With the retainer body 82 arranged in this recessed part, the front end of the retainer body 82 is in contact with an end surface of the ceiling plate portion 43c located on a front side of this recess part, and the rear end of the retainer body 82 is in contact with an end surface of the ceiling plate portion 43c located on a rear side of this recessed part. In this way, the retainer 80 is positioned in the front-rear direction.

The retainer body 82 is formed with the locking protrusions 83. Here, a plurality of the locking protrusions 83 are formed in parallel to correspond to the plurality of cavities 44. The locking protrusion 83 is formed in an intermediate part in the extension direction of the cavity 44, more specifically a region in the extension direction of the cavity 44 where the core wire crimping portion 12 is to be located. The locking protrusion 83 has a shape elongated along the extension direction of the cavity 44. A length of the locking protrusion 83 is, for example, set to be equal to or shorter than a distance between the coating crimping portion 11 and the terminal connecting portion 13 to such an extent that the terminal 10 can be positioned in the extension direction.

With the retainer body 82 attached to the complete attachment openings 36, the locking protrusions 83 are arranged at positions corresponding to the complete attachment openings 36. In the temporarily attached state of the retainer 80, the locking protrusions 83 do not project into the cavities 44 and are arranged in or outside the complete attachment openings 36. In the completely attached state of the retainer 80, the locking protrusions 83 can project into the cavities 44 from the retainer body 82. In this state, the locking protrusions 83 can be fit into the recesses 14 between the coating crimping portions 11 and the terminal connecting portions 13 of the terminals 10 in the cavities 44. In this way, the terminals 10 are positioned in the extension direction thereof and suppressed from coming out rearward.

The pair of locking wall portions 84 extend from both sides of the retainer body 82 along both sides of the terminal accommodating portion 42, here along the outer surfaces of the pair of outer walls 43a. Retaining protrusions 85 are formed at positions near tips on the inner surfaces of the pair of locking wall portions 84. The retaining protrusion 85 is a protrusion projecting from the inner surface of the locking wall portion 84. The retaining protrusion 85 is formed into a shape including a part having a projecting dimension gradually reduced toward a tip side of the locking wall portion 84. The pair of locking wall portions 84 can be locked to the pair of temporary attachment locking portions 47 or the pair of complete attachment locking portions 46.

The retaining protrusion 85 may have a protrusion shape elongated along the extension direction of the cavity 44. The retaining protrusion 85 may have a length nearly equal to those of the pair of temporary attachment locking portions 47 or the pair of complete attachment locking portions 46. In this way, the retaining protrusions 85 can be locked to the pair of temporary attachment locking portions 47 or the pair of complete attachment locking portions 46 entirely in the extension direction, and the temporarily attached state or the completely attached state of the retainer 80 is stabilized.

The locking lances 86 are parts to be temporarily locked to the terminals 10 in the cavities 44 with the retainer 80 located at the temporarily attached position.

Here, the locking lances 86 are formed to project in the same direction as the locking wall portions 84 at an intermediate position in an extension direction of the retainer body 82 so as to be arrangeable in the temporary attachment openings 38. More specifically, the locking lances 86 are parts of the retainer body 82 facing the terminal accommodating portion 42 and projecting from a part between the pair of locking wall portions 84. With the retainer 80 attached to the complete attachment openings 36, the locking lances 86 are arranged in the temporary attachment openings 38. The locking lances 86 are long in a direction orthogonal to the extension direction of the cavities 44 and configured to be resiliently deformable along a direction intersecting the extension direction of the cavities 44.

Preferably, a front-rear length of the locking lance 86 may be equal to a width of a gap in the front-rear direction of the temporary attachment opening 38 so as to be accommodated in the temporary attachment opening 38 without rattling in the front-rear direction.

In this embodiment, the base end of the locking lance 86 is integrally connected to one side of the locking protrusion 83. Thus, the locking lance 86 is reinforced as compared to the case where the locking lance 86 projects from the retainer body 82 without being connected to the locking protrusion 83. In this way, the locking lance 86 is hard to break. The locking protrusions 83 are guided toward the complete attachment openings 36 and the retainer 80 is smoothly attached by guiding the locking lances 86 in the extension direction of the cavities 44 by the temporary attachment openings 38.

The locking lance 86 includes a resilient piece 87 and a temporary locking protrusion 88.

The resilient piece 87 is an elongated part extending in a direction (here, the vertical direction) intersecting (here, orthogonal to) the extension direction of the cavity 44 and configured to be resiliently deformable in a direction (here, the lateral direction) intersecting (here, orthogonal to) the extension direction of the cavity 44. As described above, the base end of the resilient piece 87 is integrally connected to the outer surface of the locking protrusion 83. The tip of the resilient piece 87 can further project from the tip of the locking protrusion 84 and be easily resiliently deformed in the lateral direction.

The temporary locking protrusion 88 is formed to project toward the cavity 44 at a position separated from the base end of the resilient piece 87. Here, the temporary locking protrusion 88 projects toward the cavity 44 at a position separated from the tip of the locking protrusion 83.

With the locking lance 86 arranged in the temporary attachment opening 38, the temporary locking protrusion 88 can project into the cavity 44 from the temporary attachment opening 38. Thus, the temporary locking protrusion 88 can be temporarily locked to the recess 14 of the terminal 10 from the right or left of the terminal 10.

Since the temporary locking protrusion 88 is arranged at the position separated from the tip of the locking protrusion 83, the temporary locking protrusion 88 can be temporarily locked to the recess 14 before the locking protrusion 83 is locked to the recess 14. Further, the temporary locking protrusion 88 can be located at a position beyond the recess 14 with the locking protrusion 83 locked to the recess.

The temporary locking protrusion 88 has a first guide surface 88f1 and a second guide surface 88f2.

The first guide surface 88f1 is a surface of the temporary locking protrusion 88 facing obliquely rearward. The first guide surface 88f1 is a surface for gradually reducing a projecting dimension of the temporary locking protrusion 88 toward a side where the terminal 10 is inserted (rear side) in the extension direction of the cavity 44. If the terminal 10 is inserted into the cavity 44 with the temporary locking protrusion 88 projecting into the cavity 44 from the temporary attachment opening 38, the tip of the terminal 10 can contact the first guide surface 88f1.

The second guide surface 88f2 is a surface of the temporary locking protrusion 88 facing obliquely downward. The second guide surface 88f2 is a surface for gradually reducing a projecting dimension of the temporary locking protrusion 88 toward a tip side of the locking lance 86. If the temporary locking protrusion 88 projects into the cavity 44 from the temporary attachment opening 38 and is arranged in the recess 14 of the terminal 10 and the retainer 80 is pushed in this state, the second guide surface 88f2 can contact the core wire crimping portion 12.

A forward facing surface of the temporary locking protrusion 88 may be a temporary locking surface 88f3 perpendicular to the extension direction of the cavity 44. The temporary locking surface 88f3 is a surface for contacting the terminal connecting portion 13 to prevent the terminal connecting portion 13 from coming out when the terminal 10 is coming out rearward from the cavity 44. If this temporary locking surface 88f is perpendicular to the extension direction of the cavity 44, the locking lance 86 is hardly resiliently deformed in a direction to release temporary locking even if the temporary locking surface 88f3 contacts the terminal connecting portion 13. Thus, the temporarily locked state is effectively maintained.

### <Terminal Holding Operation>

A holding operation example of the terminal 10 is described.

For example, an assembly in which the pair of retaining protrusions 85 of the retainer 80 are locked to the pair of temporary attachment locking portions 47 is prepared (see FIGS. 6 and 7). In this state, the locking protrusions 83 do not project into the cavities 44. Thus, if the terminal 10 is inserted into the cavity 44 through the rear opening 45, the terminal 10 can be inserted to the back of the cavity 44, i.e. to the front side without being caught by the locking protrusion 83.

Further, in the above state, the resilient piece 87 of the locking lance 86 is arranged in the temporary attachment opening 38. The temporary locking protrusion 88 projecting from the resilient piece 87 projects into the cavity 44 from the temporary attachment opening 38. Thus, if the terminal 10 is inserted into the cavity 44 through the rear opening 45, the terminal connecting portion 13 of the terminal 10 contacts this temporary locking protrusion 88.

At this time, the tip of the terminal connecting portion 13 contacts the first guide surface 88f1 of the temporary locking protrusion 88 (see FIG. 7). As described above, the first guide surface 88f1 is the surface for gradually reducing the projecting dimension of the temporary locking protrusion 88 as the terminal 10 is inserted and moved toward the rear side. Thus, if the terminal 10 is inserted to the back of the cavity 44, the tip of the terminal connecting portion 13 contacts the first guide surface 88f1 and pushes the temporary locking protrusion 88 in a direction retracting from the cavity 44, i.e. to a right or left outer side. In this way, the terminal 10 can move to the back of the cavity 44, to the front side.

If the terminal connecting portion 13 moves beyond the temporary locking protrusion 88, the temporary locking protrusion 88 returns to the state projecting into the cavity 44 by a resilient force of the resilient piece 87 to return to an original shape. In this way, the temporary locking protrusion 88 is temporarily locked to the recess 14 of the terminal 10 (see FIG. 6).

The terminal 10 is inserted into each cavity 44 as described above. With each terminal 10 inserted in each cavity 44, the temporary locking protrusion 88 is temporarily locked to the terminal 10. Thus, if the terminal 10 is temporarily inserted into the cavity 44, an inserting operation of the terminal 10 can be successively easily performed without concern for the detachment of the terminal 10 thereafter.

With the terminals 10 respectively temporarily locked in the plurality of cavities 44, the retainer 80 is pushed from the temporarily attached position to the completely attached position.

At this time, the temporary locking protrusion 88 is pushed in a pushing direction of the retainer 80, i.e. in a downward direction orthogonal to the extension direction of the cavities 44. Then, the temporary locking protrusion 88 moves from the recess 14 toward the core wire crimping portion 12 and contacts the core wire crimping portion 12. As described above, the second guide surface 88f2 is the surface for gradually reducing the projecting dimension of the temporary locking protrusion 88 toward the tip side of the locking lance 86. Thus, the second guide surface 88f2 contacts the core wire crimping portion 12 and the temporary locking protrusion 88 moves in the direction retracting from the cavity 44, i.e. to the right or left outer side. In this way, the temporary locking protrusion 88 moves to below the core wire crimping portion 12 beyond the core wire crimping portion 12 to release temporary locking for the terminal 10. The temporary locking protrusion 88 having moved downward beyond the core wire crimping portion 12 returns to the original position on the side of the cavity 44 due to the resilient force of the resilient piece 87 and is arranged in the partial recess 44h of the cavity 44.

Instead of the temporary locking of the temporary locking protrusion 88 to the recess 14, the locking protrusion 83 enters the cavity 44 through the complete attachment opening 36. The locking protrusion 83 enters the recess 14 from a side opposite to the core wire crimping portion 12.

If the retaining protrusions 85 of the pair of locking wall portions 84 of the retainer 80 move beyond the complete attachment locking portions 46 and are retained and locked to the complete attachment locking portions 46, the retainer 80 reaches the completely attached position and is completely attached to the housing 30. In this state, the locking protrusions 83 are kept projecting into the cavities 44 and the core wire crimping portions 12 are locked from front by the locking protrusions 83. In this way, it is suppressed that the terminals 10 come out rearward from the cavities 44.

### <Effects, etc.>

According to the connector configured as described above, the retainer 80 includes the locking lances 86 temporarily lockable to the terminals 10 at the temporarily attached position and the locking protrusions lockable to the terminals 10 at the completely attached position. Thus, the shape of the housing 30 can be simplified and the connector 20 can be reduced in size.

That is, if a housing including cavities and a retainer having a function of holding terminals in the cavities are compared, the shape of the housing generally tends to be more complicated. Moreover, since a guiding structure, a locking structure and the like for connection to a mating connector are often incorporated into the housing, the shape of the housing is easily complicated also from this perspective. Thus, if the housing is formed with locking lances, it easily leads to enlargement from the perspective of mold constraints.

Accordingly, the housing 30 can be simplified in shape and reduced in size by forming the locking lances 86 in the retainer 80 as in this embodiment. Further, since the retainer 80 has a simpler shape than the housing 30, even if the retainer 80 is formed with the housing 30, mold constraints are few and the retainer 80 is hardly enlarged. Thus, the entire connector 20 can be simplified in shape and reduced in size.

Further, both the locking lance 86 and the locking protrusion 83 can be locked to the recess 14 of the terminal 10. Thus, the terminal 10 needs not be separately formed with a part to be temporarily locked by the locking lance 86. In this way, the terminal 10 can be simplified and reduced in size, which contributes to the size reduction of the connector 20.

Of course, a locking lance and a locking protrusion may be locked to a terminal at different positions.

Further, the locking lances 86 are formed to project in the same direction as the locking wall portions 84 in an intermediate part in the extension direction of the retainer body 82 so as to be arrangeable in the temporary attachment openings 38, and resiliently deformed along the direction intersecting the extension direction of the cavities 44. Thus, a configuration for forming the locking lance 86 can be made smaller as compared to the case where a locking lance is postured to extend along an extension direction of a cavity. In this way, the size in the front-rear direction of the connector 20 can be reduced.

Note that a locking lance may extend along an extension direction of a cavity. For example, the locking lance may project from a locking wall portion along the extension direction of the cavity and a side part of a housing may be formed with an opening, in which this locking lance can be arranged.

Further, the base end of the locking lance 86 is integrally connected to the locking protrusion 83. Thus, the locking lance 86 is reinforced and hard to broken.

Further, the locking lance 86 includes the resilient piece 87 and the temporary locking protrusion 88, and the locking lance 86 is arranged in the temporary attachment opening 38 and the temporary locking protrusion 88 projects into the cavity 44 and is separably locked to the recess of the terminal 10 with the retainer 80 located at the temporarily attached position. With the retainer 80 located at the completely attached position, the temporary locking protrusion 88 moves beyond the terminal 10 to release temporary locking for the terminal 10. Instead, the retainer body 82 is attached to the complete attachment opening 36 and the locking protrusion 83 projects into the cavity 44 and locked to the recess of the terminal 10.

Thus, the locking lance 86 can be temporarily locked to the terminal 10 with the retainer 80 located at the temporarily attached position. If the retainer 80 is pushed and moved to the completely attached position, the temporary locking of the locking lance 86 and the terminal 10 is released and the locking protrusion 83 is temporarily locked to the terminal 10.

If the locking lance 86 and the locking protrusion 83 are at the same position or at least partially overlap in the extension direction of the terminal 10, a configuration for locking the locking lance 86 and the locking protrusion 83 to the recess 14, i.e. the same location of the terminal 10, is easily realized.

Further, the temporary locking protrusion 88 has the first guide surface 88f1 and the second guide surface 88f2. Thus, if the terminal 10 is inserted into the cavity 44 with the retainer 80 located at the temporarily attached position, the terminal 10 can contact the first guide surface 88f1. In this way, the locking lance 86 is easily resiliently deformed in the direction retracting from the cavity 44. If the terminal 10 is further pushed in, the locking lance 86 resiliently returns to the original shape and the temporary locking protrusion 88 can be temporarily locked to the terminal 10.

Further, if the retainer 80 is pushed from the temporarily attached position toward the completely attached position, the second guide surface 88f2 contacts the terminal 10 and the locking lance 86 can be easily resiliently deformed in the direction retracting from the cavity 44. Thus, the temporary locking protrusion 88 moves beyond the terminal 10 to release the temporary locking of the locking lance 86 and the terminal 10. In this way, it is easily realized that the locking lance 86 is temporarily locked to the terminal 10 by the insertion of the terminal 10 and the temporary locking of the locking lance 86 and the terminal 10 is released by pushing the locking lance 86.

Further, after the locking of the locking lance 86 and the terminal 10 is released, the locking protrusion 83 can be easily locked to the recess 14.

Note that the locking lance may be kept temporarily locked to the terminal 10 with the locking protrusion 83 locked to the recess 14.

Further, the housing 30 includes the outer walls 43a as vertical walls, and the temporary attachment openings 38 are formed in the outer walls 43a and formed as slits along the projecting direction of the locking wall portions 84. Thus, the retainer 80 is guided by the configuration in which the locking lances 86 are arranged in the slit-like temporary attachment openings 38. Further, the locking lances 86 are easily resiliently deformed, utilizing spaces in the slits.

Further, if the temporary attachment opening 38 is formed in the outer wall 43a, a space enabling the locking lance 86 to be resiliently deformed outwardly of the outer wall 43a is easily ensured. In this way, even if the temporary locking protrusion 88 sufficiently projects into the cavity 44, the locking lance 86 can be largely resiliently deformed outward. By causing the temporary locking protrusion 88 to sufficiently project into the cavity 44, a state where the locking lance 86 is temporarily locked to the terminal 10 is easily maintained.

Further, the slit-like temporary attachment opening 38 crosses the temporary attachment locking portion 47 and the complete attachment locking portion 46. Thus, the retaining protrusion 85 of the locking wall portion 84 is locked to the temporary attachment locking portion 47 or the complete attachment locking portion 46 near the position where the locking lance 86 is guided by the temporary attachment opening 38. Thus, the retaining protrusion 85 of the locking wall portion 84 can be smoothly locked to the temporary attachment locking portion 47 or the complete attachment locking portion 46.

Further, in the configuration in which both the locking lance 86 and the locking protrusion 83 are locked to the recess 14 at the same position in a longitudinal direction of the terminal 10, the locking protrusion 83 is locked to the terminal 10 in an intermediate part of a locking region of the retaining protrusion 85 and the complete attachment locking portion 46. Thus, the terminal 10 is more firmly retained by the locking protrusion 83.

Note that a connector may include three or more arranged cavities. In this case, a temporary attachment opening may be formed in a wall partitioning between the cavities and a locking lance may be arranged in this temporary attachment opening.

Further, the above configuration is applicable also to a configuration in which terminals inserted into cavities in a plurality of stages are retained by the same retainer. For example, a plurality of the retainer bodies 82, a plurality of the locking protrusions 83, a plurality of the locking lances 86 may be provided to correspond to a plurality of stages.

Note that the respective configurations described in the above embodiment and the respective modifications can be appropriately combined without contradicting each other.

### LIST OF REFERENCE NUMERALS

10 terminal
11 coating crimping portion
12 core wire crimping portion
13 terminal connecting portion
14 recess
18 wire
20 connector
30 housing
31 partitioning plate portion
31F front plate portion
31Fa connection hole
32, 42 terminal accommodating portion
34, 44 cavity
36 temporary attachment opening
38 complete attachment opening
43a outer wall (vertical wall)
43b intermediate wall (vertical wall)
43c ceiling plate portion
44h recess
45 rear opening
46 complete attachment locking portion
47 temporary attachment locking portion
60 cover
80 retainer
82 retainer body
83 locking protrusion
84 locking wall portion
85 retaining protrusion
86 locking lance
87 resilient piece
88 temporary locking protrusion
88f1 first guide surface
88f2 second guide surface
88f3 temporary locking surface

1. A connector for holding a terminal, comprising:
a housing formed with a cavity capable of accommodating the terminal; and
a retainer attachable to the housing at a temporarily attached position and a completely attached position,
the retainer including a locking lance temporarily lockable to the terminal in the cavity at the temporarily attached position and a locking protrusion lockable to the terminal in the cavity at the completely attached position.

2. The connector of claim 1, wherein:
the terminal includes a recess recessed in a part in an extension direction thereof, and
the locking lance is temporarily lockable to the recess and the locking protrusion is lockable to the recess.

3. The connector of claim 1, wherein:
the housing includes a complete attachment opening and a temporary attachment opening,
the retainer includes a retainer body to be attached to the complete attachment opening and a pair of locking wall portions extending from both sides of the retainer body along both sides of the housing,
the locking protrusion is formed to project into the cavity from the retainer body, and
the locking lance is formed to project in the same direction as the locking wall portions at an intermediate position in an extension direction of the retainer body as to be arrangeable in the temporary attachment opening, and resiliently deformable along a direction intersecting an extension direction of the cavity.

4. The connector of claim 3, wherein a base end of the locking lance is integrally connected to the locking protrusion.

5. The connector of claim 3, wherein:
the locking lance includes a resilient piece and a temporary locking protrusion projecting toward the cavity at a position separated from a base end of the resilient piece,
the locking lance is arranged in the temporary attachment opening and the temporary locking protrusion projects into the cavity and is temporarily lockable to the terminal in the cavity with the retainer located at the temporarily attached position, and
the temporary locking protrusion moves beyond the terminal to release temporary locking for the terminal and the locking protrusion projects into the cavity to be lockable to the terminal in the cavity with the retainer located at the completely attached position.

6. The connector of claim 5, wherein the temporary locking protrusion has a first guide surface for gradually reducing a projecting dimension of the temporary locking protrusion toward a side where the terminal is inserted in an extension direction of the cavity and a second guide surface for gradually reducing a projecting dimension of the temporary locking protrusion toward a tip side of the locking lance.

7. The connector of claim 3, wherein:
the housing includes a vertical wall along the extension direction of the cavity and a projecting direction of the locking wall portions, and
the temporary attachment opening is a slit formed in the vertical wall and along the projecting direction of the locking wall portions.

8. The connector of claim 7, wherein:
the vertical wall includes an outer wall exposed on any one of side surfaces of the housing, and
the temporary attachment opening is a slit formed in the outer wall.

9. The connector of claim 7, wherein:
the housing includes a pair of temporary attachment locking portions to be temporarily locked to the pair of locking wall portions with the retainer located at the temporarily attached position and a pair of complete attachment locking portions to be locked to the pair of locking wall portions with the retainer located at the completely attached position,
the pair of temporary attachment locking portions and the pair of complete attachment locking portions are formed into a protrusion shape elongated in the extension direction of the cavity, and
the temporary attachment opening is a slit formed to cross at least one of the pair of temporary attachment locking portions and at least one of the pair of complete attachment locking portions.
